(19) United States
(12) Patent Application Publication
(10) Pub. No.: US 2025/0074123 A1
(43) Pub. Date: Mar. 6, 2025

(54) FLAPPER PINTLE HITCH

(71) Applicant: Polaris Industries Inc., Medina, MN (US)

(72) Inventors: Barry Johnson, Roseau, MN (US); Matthew Prusak, Salol, MN (US); William Bryant, Roseau, MN (US)

(21) Appl. No.: 18/817,688

(22) Filed: Aug. 28, 2024

Related U.S. Application Data
(60) Provisional application No. 63/579,152, filed on Aug. 28, 2023.

(51) Int. Cl. B60D 1/02; B60D 1/00; B62M 27/02

(52) U.S. Cl. CPC B60D 1/025; B62M 27/02; B60D 2001/001; B62M 2027/028

(57) ABSTRACT

A snowmobile hitch has a pintle hitch portion and a flapper hitch portion. A hitch body has a rearward projection pintle hitch horn and a portion that pivotally supports a pintle hook movable toward and away from the horn for opening and closing the pintle hitch portion. The hitch further having a V-shaped flapper that is pivotally engaged with the hitch body by way of one or may polymeric spacers providing friction reduction and noise attenuation when moving the flapper, as well as positional fixation. The spacers having a detent for engaging with respective projection on the hitch body. The hitch further having a latch with a pivot pin, a locking pin portion, and a handle. Manipulating the handle can unlock the pintle hitch hook from one of the open and closed positions and move the hook to the other of the open and closed positions.

### CROSS REFERENCE TO RELATED APPLICATIONS

This application claims priority to U.S. Provisional Application No. 63/579,152 filed Aug. 28, 2023, titled FLAPPER PINTLE HITCH, the entire disclosure thereof expressly incorporated by reference herein.

### BACKGROUND OF THE INVENTION

Snowmobiles are popular for recreational purposes but are also a mainstay for necessary operations in such arenas as running ski areas, wilderness rescues, transportation of freight in remote areas or just places not served by plowed roads. In all such contexts, snowmobiles may be utilized for towing, such as for towing other disabled snowmobiles, injured skiers on a ski hill, kids in a toboggan, or necessary supplies in remote areas. To the extent that a hitch can provide varied and versatile connection options, such would be well received by the snowmobile industry and consuming public.

### SUMMARY

Snowmobiles have various hitching options, for example, flapper hitches have a horizontally hinged plate with a hole for receiving a hook, cable, or rope. The plate may fold down when not in use to be out of the way. However, such hitches can be noisy with the plate bouncing around when in rough terrain and may not be convenient for heavy loads. Pintle hitches are known and provide such a secure hitch with a mechanism to open and close the hitching jaws. But pintle hitches are not convenient for towing uses such as for towing light loads with ropes such as sleds and toboggans. Although ball hitches have been used on snowmobiles, generally they are considered to be better suited to towing loads on roads with road vehicles.

A feature and advantage of embodiments is a hitch for snowmobiles having attributes of the security, and high load capacity of a pintle hitch and the convenience of a flapper hitch without the associated noise and unwanted flapping of the flapper.

A snowmobile hitch has a pintle hitch portion and a flapper hitch portion. A hitch body has a rearward projecting pintle hitch horn and a portion that pivotally supports a pintle hook movable toward and away from the horn for opening and closing the pintle hitch portion. The hitch further having a V-shaped flapper that is pivotally engaged with the hitch body by way of one or more spacers, made from polymers or other materials, providing friction and noise attenuation when moving the flapper, as well as positional fixation. The spacers may have a detent for engaging with respective projection on the hitch body. In embodiments, the hitch further having a latch with a pivot pin, a locking pin portion, and a handle. Manipulating the handle can unlock the pintle hitch hook from one of the open and closed positions and move the hook to the other of the open and closed positions.

A feature and advantage of embodiments is a flapper hitch where the flapper has retention in either a downward unhitched position or an upward hitched position. A feature and advantage of embodiments is polymer components for providing retention of the flapper also provide sound reduction or elimination caused by the flapper movement with respect to the plate.

A hitch suitable for a snowmobile provides a conventional pintle hitch and a flapper hitch with a flapper that is retained out-of-the way when not in use.

A feature and advantage of embodiments is a flapper hitch for offroad vehicles that provides noise reduction and position retention of the flapper. A further feature and advantage is a flapper V-shape that provides a wide aperture for easily and quickly receiving a hook or rope which is very convenient for light or small towing loads. A further feature and advantage of embodiments is the V-shaped flapper with an aperture at the apex of the V-shaped flapper for attachment of a tow line. A further feature and advantage of the V-shaped flapper is that a pair of pin bosses on leg ends of the flapper are separated from the flapper pivot pin support portion of the hitch body by a pair of spacer members that may be, for example, a polymeric material. The spacer members may have form fit portions to the legends and provide frictional resistance between the flapper leg ends and the hitch body for positional retention of flapper.

A feature and advantage of embodiments is a pintle hitch comprising a fixed lower horn and a hinged pintle hook that pivots on a horizontal axis and that is latchable in an open position or a closed position by way of a latch with an easily graspable operating handle that latches and unlatches the latching member by pulling the handle an incremental amount in a horizontal direction parallel to the axis of the hinged pintle hook and that may then be utilized to raise or lower the pintle hook to the open or closed position by a minimal rotation of the handle. In embodiments the latch may provide a pivot pin about which the pintle hook rotates between the open and closed positions and may also provide a locking or detent portion that locks the pintle hook in the open and closed position. In embodiments the latch has a spring to urge the detent portion into the lock position. In embodiments, the detent portion and the pivot pin are unitary.

A feature and advantage of embodiments is that polymer noise limiting member or members may be positioned between a flapper and a hitch body thereby providing elimination or reduction of noise generation of a flapper hitch. In embodiments the noise limiting members may also provide position retention by generating friction when the flapper is pivoted and may also provide position fixation by a detent formed in the polymer component that engages with a projection on the hitch body.

A feature and advantage of embodiments is a combination pintle hitch and flapper hitch that can also be utilized on other off road vehicles such as UTVs and ATVs.

A feature and advantage of embodiments is a pintle hitch where a latch with a handle that manipulates the latch to unlock and lock a hook in open or closed positions also is utilized to move the hook between the open and closed position. In other words, a user may with one hand both release the hook from the open or closed position and move the hook to the other of the open and closed position where it may lock. A user with a simple pulling, twisting, and pushing motion may open or close the pintle hitch. In embodiments, the hitch has a spring to urge the latch to a lock position, the user may simply pull and rotate the handle to position the hook in either the open or closed position, and the latch automatically locking into the open or closed position. In embodiments, when in the closed position, the hook and horn have a slight gap therebetween that provides noise reduction in that the hook and horn may be prevented from clanging together when a snowmobile to which the hitch is attached is moving. The gap may be, for example, 1/64 to ⅜ of an inch.

In embodiments, a hitch for a snowmobile has a hitch body having a forward mounting plate portion with a plurality of mounting holes, a pintle hook support portion extending rearwardly, a pivot pin aperture extending therethrough, and further having two horizontally extending locking aperture openings, the hitch body further having a pintle hitch horn extending rearwardly and a flapper support portion. The hitch further having a pintle hitch latch with a pivot pin and a locking pin portion in a fixed relationship, the pivot pin extending horizontally through the pintle hitch hook support portion, the locking pin portion extendable into either of the two locking aperture openings providing a pair of locked positions and being retractable from either of the two locked positions to a transition position. The hitch further having a pintle hook pivotally attached to the hitch body at the pintle hood support portion at the pintle hitch latch pivot pin, the pintle hook movable from an open to a closed position by moving the locking pin portion to the transition position and rotating the pintle hitch latch. The hitch further having a V-shaped flapper having a pair of arms with arm ends, the arm ends pivotally attached to the flapper support portion of the hitch body, the V-shaped flapper hitch movable between a downward position and an upward position. The hitch further having a pair of spacers positioned between the arm ends of the V-shaped flapper and the hitch body providing resistance to movement of the V-shaped flapper and sound reduction of such movement.

In embodiments, a hitch has a hitch body and a V-shaped flapper connected to the hitch body, the V-shaped flapper having a pair of arms joined at an apex and separated at the hitch body, each of the pair of arms having an arm end pivotally attached to the hitch body, the hitch further comprising a pair least one polymeric spacers positioned at each of the pair of arm ends and interfacing with the pair of arm ends and with the hitch body thereby providing resistance to pivotal motion of the flapper with respect to the hitch body.

In embodiments, a hitch comprising a hitch body with pintle hitch support portion and a pintle horn, the hitch further comprising a pintle hook pivotally attached to the hitch body, the hitch further comprising a pintle hitch latch having a pivot pin and a locking pin portion in a fixed relationship, the pivot pin extending horizontally through the pintle hitch hook support portion, the locking pin portion extendable into either of two locking aperture openings in the pintle hook supporting portion providing a pair of lockable positions where the hitch is open and closed.

In embodiments, a hitch comprising a hitch body having a pintle horn and a V-shaped flapper connected to the hitch body, the V-shaped flapper having a pair of arms joined at an apex and separated at the hitch body, each of the pair of arms having an arm end pivotally attached to the hitch body, the hitch further comprising a pintle hook pivotally attached to the hitch body.

In embodiments the four holed mounting plate may be replaced by a draw bar such configured with square metal tubing to be received in a conventional square hitch receiver common on off-road vehicles and road vehicles.

### DESCRIPTION OF THE FIGURES

FIG. 1 is a perspective view of a rear end of a snowmobile with a hitch in accord with embodiments attached thereto.

FIG. 2 is a perspective view of an embodiment of the hitch.

FIG. 3 is a side elevational view of the hitch of FIG. 2.

FIG. 4 is a is a perspective view of the hitch of FIGS. 2 and 3 with the flapper in an upward position and the pintle hitch portion in a closed position.

FIG. 5 is a rear perspective view of the hitch of FIGS. 2-4.

FIG. 6 is a perspective view of another embodiment of a hitch with the pintle hitch portion closed.

FIG. 7 is a cross sectional view taken at line 7-7 of FIG. 3.

FIG. 8 is a cross sectional view taken at line 8-8 of FIG. 3.

FIG. 9 is an exploded view of a hitch showing alternate latches for the pintle hitch portion.

FIG. 10 is a perspective view of the pintle hitch hook.

FIG. 11 is a perspective view of the hitch body.

FIG. 12 is a perspective view of the pair of spacers.

FIG. 13 is a perspective view of another embodiment of a hitch with the flapper in a downward unsecured position.

FIG. 14 is a perspective view of the hitch of FIG. 13 with the flapper in an upward secured position.

FIG. 15A is a perspective view of the hitch of FIG. 13 with the pivot pin and flapper removed.

FIG. 15B is an exploded view of the hitch of FIG. 15A.

FIG. 16 is a perspective view of an embodiment of a flapper.

FIG. 17 is a cross sectional side view of the hitch of FIG. 13 taken along the 17-17 line.

### DETAILED DESCRIPTION

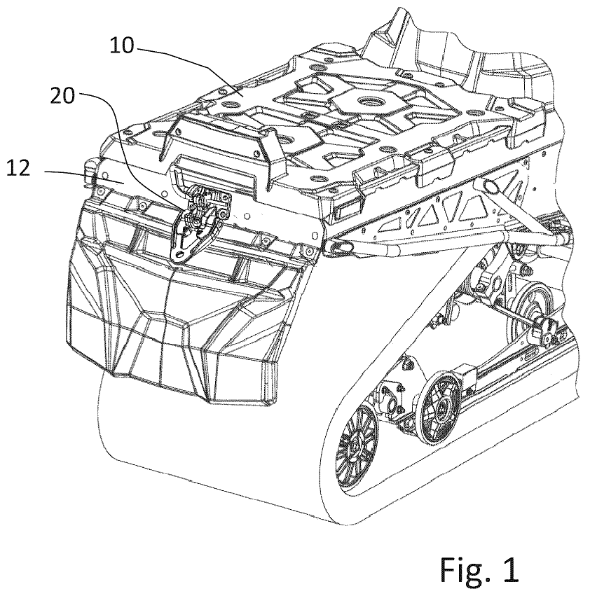

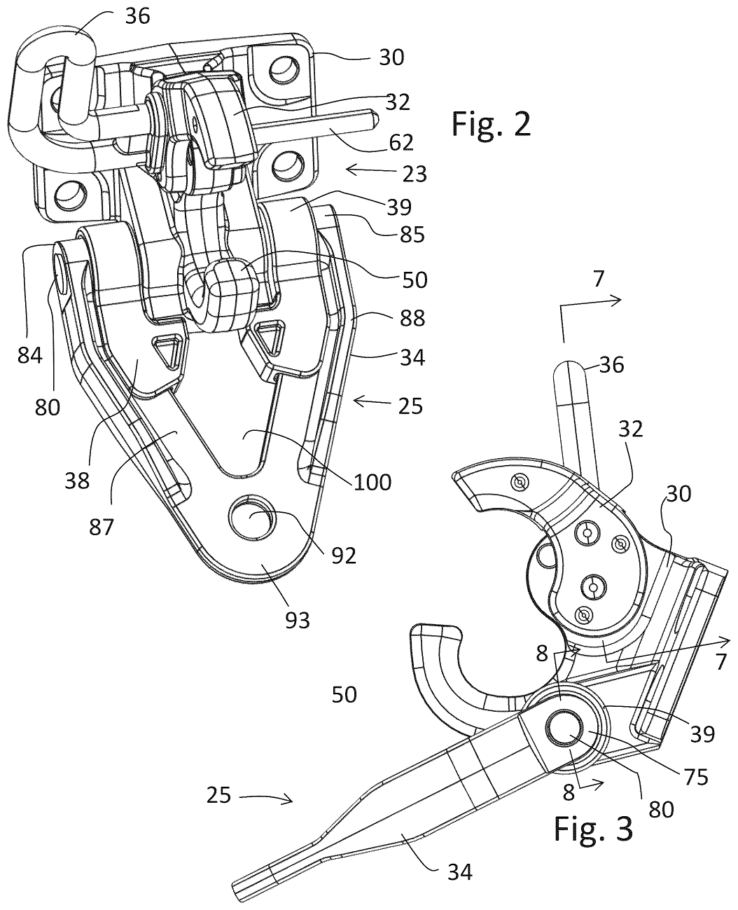

Referring to FIG. 1 a snowmobile 10 has a rearward support plate 12 with a combination pintle and flapper hitch 20. Referring to FIGS. 2-5 and 9, the hitch 20 has a pintle hitch portion 23 and a flapper hitch portion 25. In embodiments, the components of the hitch generally comprise a hitch body 30, a pintle hitch hook 32, a flapper 34, a latch 36, and spacers 38, 39. The hitch body 30 has a forward mounting plate portion 40. “Forward” being consistent with the forward direction of the snowmobile 10. The mounting plate portion 40 having a plurality of mounting holes 42. The hitch body 30 further having a pintle hook support portion 44 having a pivot pin aperture 46 and two locking openings 48, 49. The hitch body further having a pintle hitch horn 50 and a flapper support portion 54.

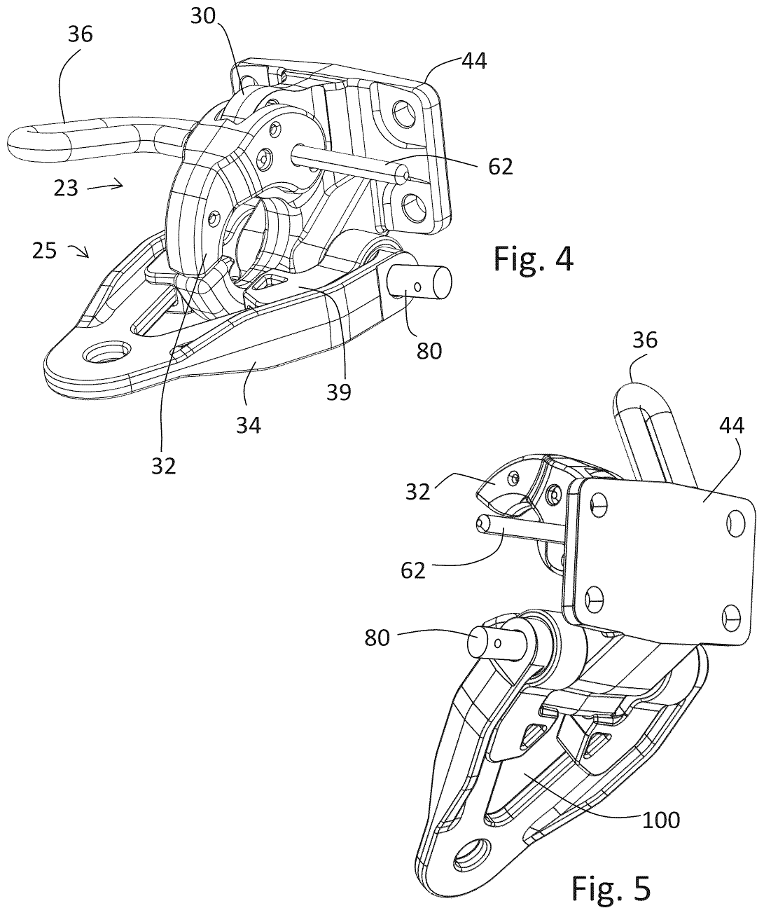

Referring to FIGS. 2-4, 7, and 9, the pintle hitch latch 36 has a pivot pin 62, a locking pin portion 64, a flange 65, and a handle portion 66. The pivot pin 62 extends through the hitch body 30 at aperture 46 and also extends through apertures 68, 69 of the two legs 70, 71 of the pintle hitch hook 32 such that the hook is pivotally attached to the hitch body 30 to closely confront or engage the horn 50 reflecting the closed position of the pintle hitch portion 23 as shown in FIG. 4, and rotatable upwardly away from the horn 50 to an open position as shown in FIGS. 2 and 3. The pintle hitch hook 32 has a pair of coaxial locking apertures 76, 77 that receive the locking pin portion 64 of the pintle hitch latch 60. The two openings 48, 49 provided in the pintle hook support portion 42 are alternately alignable with the locking apertures 76, 77 to receive the locking pin portion 64 thereby providing a releasable lock in the open position and in the closed position.

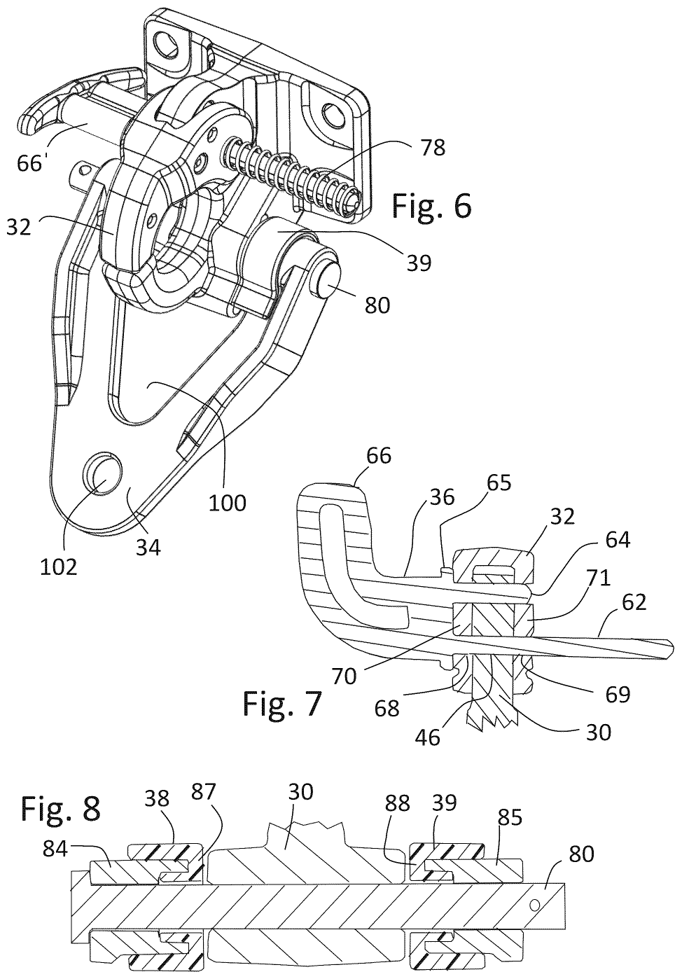

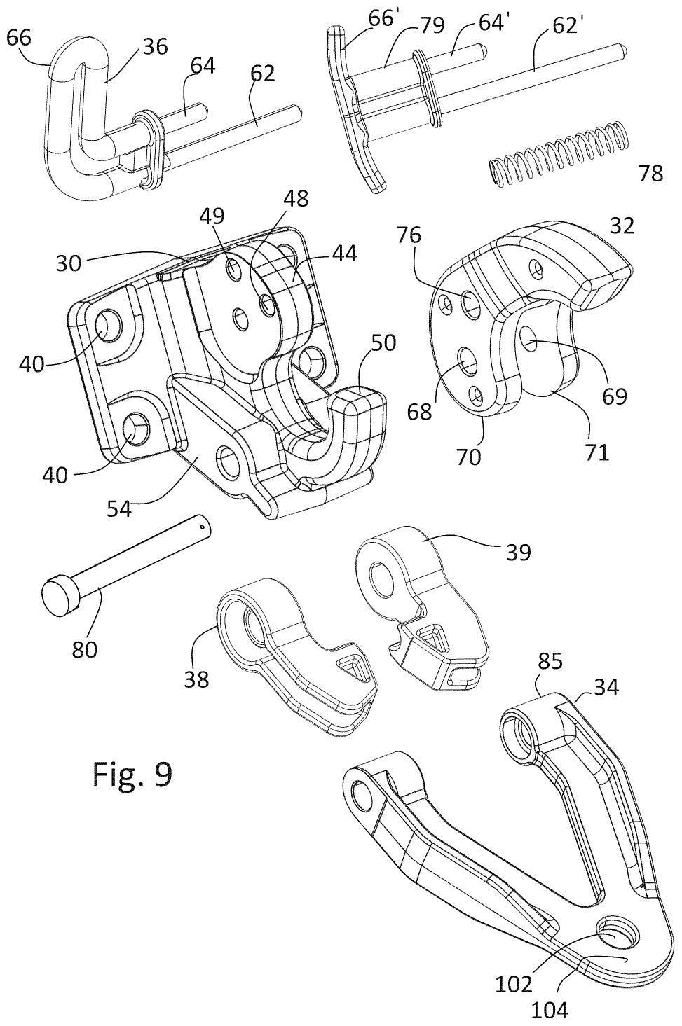

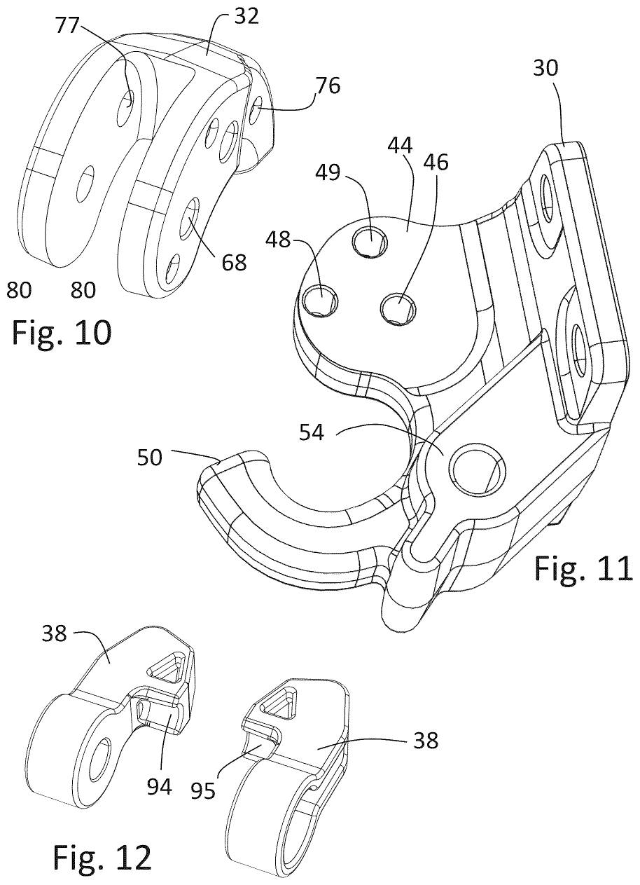

FIGS. 6 and 9 depict an alternate embodiment of a latch 79, that also has a pivot pin 62′, a locking pin portion 64′, a flange 65′, and a handle 66′. A spring 78 secured at the end tip 83 of pin portion 62′ may provide resistance to the outward horizontal pulling of the handle 66′ and also bias of the locking pin portion 64′ into the locking position with respect to the hitch body 30.

Referring to FIGS. 2-4, and 8, in embodiments, the flapper 34, in embodiments is V-shaped and is pivotally attached to the flapper support portion 54 of the hitch body 30 at the arm ends 84, 85 of the arms 87, 88 of the flapper. A flapper pivot pin 80 extends through the openings in the arm ends and a pivot pin opening 82 in the flapper support portion 54. Spacers 38, 39 are conformingly sized to the arm ends 84, 85 and have spacing portions 86, 87 positioned intermediate the arm ends and the flapper support portion 54. The spacers may further have arm engagement portions 90, 91 such that the spaces rotate upwardly and downwardly with the flapper, and detents 94, 95 that are engageable with projections 97, 98 of the flapper support portion 54 of the hitch body 30. Engagement of the hitch body projections 97, 98 with the detents 94, 95 provide a position fixation of the flapper in a lower position as shown in FIGS. 2 and 3. The spacers 38, 39, separating the flapper from direct contact with the hitch body, and in embodiments, providing position fixation, eliminating noise generation normally associated with such metal components movable with respect to one another, providing a smooth but resistive movement when manually moved, and providing angular position retention of the flapper.

The V-shaped flapper defining a first hitch opening 100 by the two arms 87, 88 and the hitch body 30, and a second opening 102 at the apex portion 104 of the flapper.

The main components of the hitch, such as the body, the flapper, the latches, and the hook, may be formed from metal such as by forging, machining, printing, or metal injection molding. The spacers may be formed by injection molding polymers.

In embodiments, the hitch may utilize a single polymeric spacer rather than two. In embodiments, the hitch may have a separate locking pin and pivot pin with respect to the pintle hitch portion.

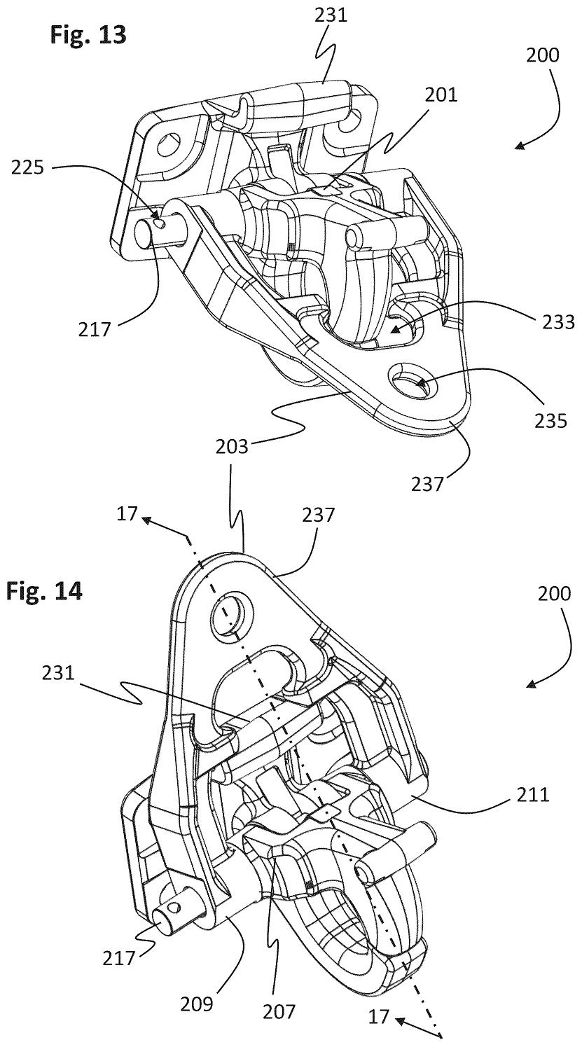

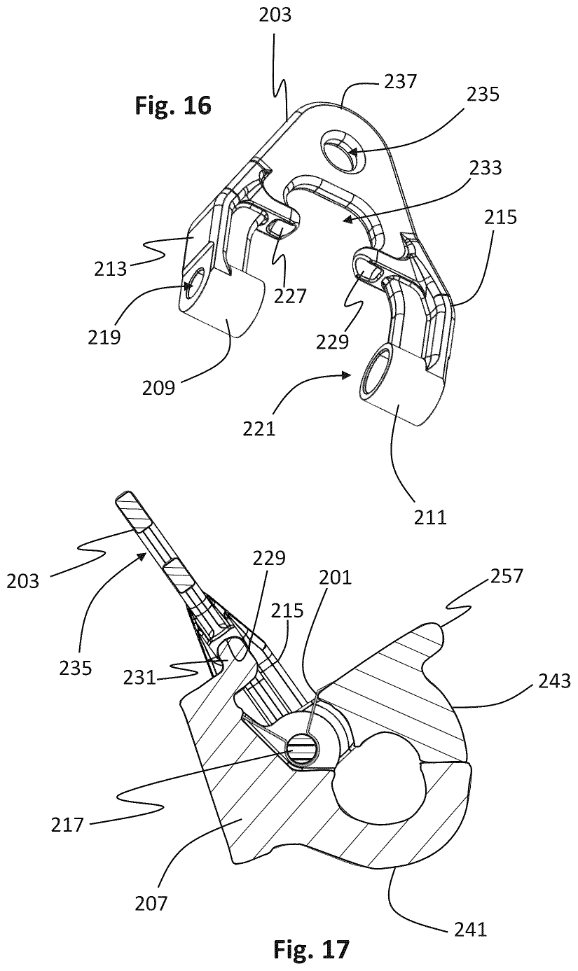

FIGS. 13-17 depict another embodiment of a hitch 200 that utilizes an internal spring mechanism, such as a leaf spring 201, that acts a latch. Referring to FIGS. 13-14 and 16, in embodiments, the flapper 203, in embodiments is V-shaped and is pivotally attached to the flapper support portion 205 of the hitch body 207 at the arm ends 209, 211 of the arms 213,215 of the flapper. The V-shaped flapper 203 defines a first hitch opening 233 by the arms 213,215 and hitch body 207, and a second opening 235 at the apex portion 237 of the flapper. A pivot pin 217 extends through the openings 219, 221 in the arm ends and a pivot pin opening 223 in the pivot pin support portion 205. In some embodiments, pivot pin 217 may have a through hole 225 at one or more ends to receive a cotter pin or the like to keep the pivot pin 217 in place. In some embodiments pivot pin 217 may have an enlarged end to prevent the pin from sliding completely through openings 219, 221. In some embodiments, arms 213,215 of the flapper may include detents 227, 229 that engage with a projection 231 from hitch body 207. Engagement of the hitch body projection 231 with the detents 227, 229 provide a position fixation of the flapper in an upper position as shown in FIG. 14. In some embodiments, spacers may be conformingly sized to fit between arms 213,215 and hitch body projection 231. In some embodiments, spacers may be conformingly sized to fit between arms 213, 215 and pivot pin 207. In some embodiments, spacers may eliminate noise generation.

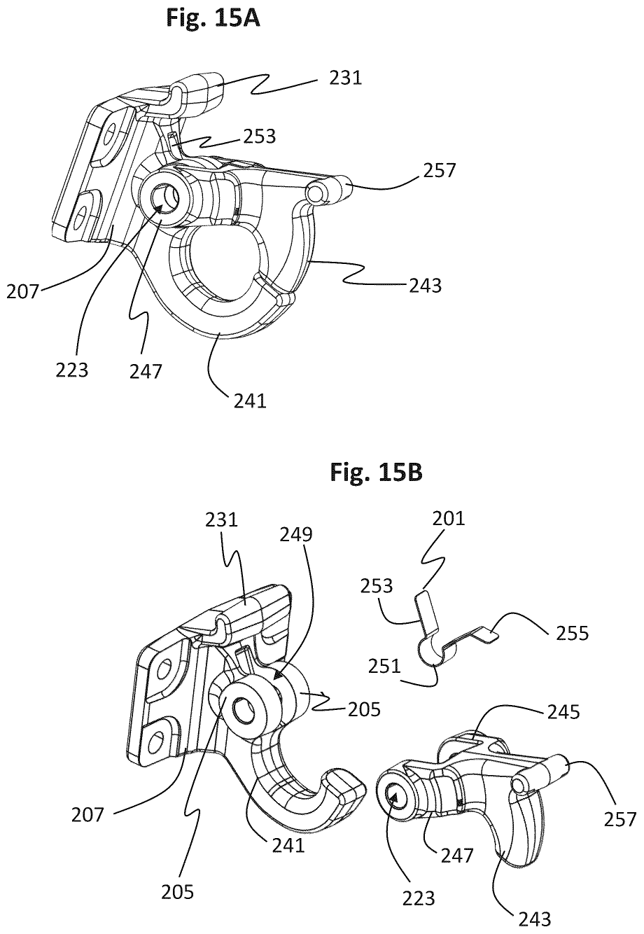

Referring to FIGS. 15 and 17, the hitch body 207 further having a pintle hitch horn 241. A pintle hitch hook 243 has arms 245, 247 with openings 223 at ends that surround pivot pin support portion 205, a latch, which may be a leaf spring 201, is sandwiched within a gap 249 between pivot pin support portions 205. Leaf spring 201 may have an arcuate central portion 251 that generally conforms to pivot pin 217, a first arm 253 that presses against hitch body 207, and a second arm 255 that generally confirms to and presses against pintle hitch hook 243. Pintle hook 243 may have a projection or handle 257 to allow for easier operation. Pintle hitch hook 243 may be opened by raising the hook, which will compress the second leaf arm 255 towards first arm 253. When the hook 243 is released, the bias in leaf spring 201 will return hook 243 back to a closed position. In embodiments, flapper and pintle hitch horn share a common pivot pin. In embodiments, the pintle hitch hook is sandwiched between flapper arms.

When “vertical” or “horizontal” or other forms of those words are used herein, such usage does not require precise vertical or horizontal alignment. “Vertical” meaning only generally more vertical than horizontal for instance; “horizontal” meaning more horizontal than vertical, for instance. When “portion” is used herein, such may refer a distinct member that is separable from other adjoining members, or it may refer to a region or section of a component that is unitary or integral with the rest of the component.

All the features disclosed in this specification (including the references incorporated by reference, including any accompanying claims, abstract and drawings), and/or all of the steps of any method or process so disclosed, may be combined in any combination, except combinations where at least some of such features and/or steps are mutually exclusive. In some examples, the arrangement of components of hitches and snowmobiles may be the same as or substantially similar to one or more of the arrangement of hitches and snowmobiles described in U.S. Pat. Nos. 5,853,187; 6,789,815; 9,446,810; and 11,110,994 and U.S. Pat. Publication 2003/0062708, the disclosure of which are incorporated herein by reference in its entirety.

The following clauses illustrate example subject matter described herein.

Clause 1. A hitch for a snowmobile comprising:
a hitch body, the hitch body having a forward mounting plate portion with a plurality of mounting holes, a pintle hook support portion extending rearwardly, a pivot pin aperture extending therethrough, and further having two horizontally extending locking aperture openings, the hitch body further having a pintle hitch horn extending rearwardly and a flapper support portion;
a pintle hitch latch having a pivot pin and a locking pin portion in a fixed relationship, the pivot pin extending horizontally through the pintle hitch hook support portion, the locking pin portion extendable into either of the two locking aperture openings providing a pair of locked positions and retractable from either of the two locked positions to a transition position;
a pintle hook pivotally attached to the hitch body at the pintle hood support portion at the pintle hitch latch pivot pin, the pintle hook movable from an open to a closed position by moving the locking pin portion to the transition position and rotating the pintle hitch latch;
a V-shaped flapper having a pair of arms with arm ends, the arm ends pivotally attached to the flapper support portion of the hitch body, the V-shaped flapper hitch movable between a downward position and an upward position;
a pair of spacers positioned between the arm ends of the V-shaped flapper and the hitch body providing resistance to movement of the V-shaped flapper and sound reduction of such movement.

Clause 2. The hitch of clause 1, wherein the flapper support portion of the hitch body has an aperture extending therethrough and the V-shaped flapper is pivotally supported at the flapper support portion by a flapper pin extending through the aperture and through a pair of openings in respective ones of the arm ends of the flapper.

Clause 3. The hitch of clause 1 or 2, wherein each of the pair of spacers extend at least partially around the arm ends of the V-shaped flapper.

Clause 4. The hitch of clause 1, 2, or 3, further comprising a spring connected between the hitch body and the pintle hitch latch for urging the latch toward one of the two lock positions.

Clause 5. The hitch of any of the above clauses, wherein the V-shaped flapper has a hole position at a rearward apex.

Clause 6. The hitch of any of the above clauses, wherein the hitch has a detent to provide a position fixation of the flapper.

Clause 7. The hitch of any of the above clauses, wherein at least one of the spacers has a detent that cooperates with a projection on the hitch body to provide the position fixation of the flapper.

Clause 8. The hitch of any of the above clauses, wherein the hook is releaseable from one of an locked open and closed position and is movable to the other of the open and closed position by grasping, the handle, pulling the handle, and rotating the handle.

Clause 9. A hitch comprising a hitch body and a V-shaped flapper connected to the hitch body, the V-shaped flapper having a pair of arms joined at an apex and separated at the hitch body, each of the pair of arms having an arm end pivotally attached to the hitch body, the hitch further comprising at least one polymeric spacers positioned at each of the pair of arm ends and interfacing with said pair of arm ends and with the hitch body thereby providing resistance to pivotal motion of the flapper with respect to the hitch body.

Clause 10. The hitch of clause 9, wherein the polymeric spacers are configured to rotate with the flapper when the flapper rotates, and wherein each spacer has a recess therein to interface with a respective one of a pair of projections on the hitch body to provide a positional fixation of the flapper with respect to the hitch body.

Clause 11. The hitch of clause 9 or 10, wherein the hitch body has rearward projecting horn and further has a pintle hook support portion; wherein the hitch further comprises a hook pivotally attached to the hitch body at the pintle hook support portion, the hook movable between an open and a closed position with respect to the horn.

Clause 12. The hitch of clause 11, wherein the hook is lockable in either of the open and the closed positions.

Clause 13. The hitch of clause 11 or 12, further comprising a latch having a pivot pin, a locking pin portion, and a handle, and wherein the position of the hook and the locking of the hook is manipulatable by the handle.

Clause 14. A hitch comprising a hitch body with pintle hitch support portion and a pintle horn, the hitch further comprising a pintle hook pivotally attached to the hitch body, the hitch further comprising a pintle hitch latch having a pivot pin and a locking pin portion in a fixed relationship, the pivot pin extending horizontally through the pintle hitch hook support portion, the locking pin portion extendable into either of two locking aperture openings in the pintle hook supporting portion providing a pair of lockable positions where the hitch is open and closed.

Clause 15. The hitch of clause 14, wherein the handle of the latch is manipulatable to unlock the hook from a locked position at one of the open and closed position and to move the hook to the other of the open and closed positions by a pulling and twisting motion.

Clause 16. The hitch of clause 14 or 15, wherein the hitch body further comprises a flapper support portion, and the hitch further comprises a flapper.

Clause 17. The hitch of clause 16, wherein the flapper is V-shaped.

Clause 18. The hitch of clause 17, wherein the V-shaped flapper defines a pair of arms each with an arm end, and wherein the V-shaped flapper is pivotally connected to the hitch body at the arm ends, and wherein the hitch further comprises a pair of spacers, with the spacers respectively interfacing with one of the arm ends and the hitch body.

Clause 19. The hitch of clause 18, wherein each of the pair of spacers comprises a polymer and is configured to rotate as the flapper rotates with respect to the hitch body, and wherein the spacer provides friction to resist rotation of the flapper with respect to the hitch body.

Clause 20. The hitch of clause 18 or 19, wherein each of the spacers comprises a detent that is engageable with a respective projection on the hitch body to provide a positional fixation of the flapper with respect to the hitch body.

Clause 21. A hitch comprising a hitch body having a pintle horn and a V-shaped flapper connected to the hitch body, the V-shaped flapper having a pair of arms joined at an apex and separated at the hitch body, each of the pair of arms having an arm end pivotally attached to the hitch body, the hitch further comprising a pintle hook pivotally attached to the hitch body.

Clause 22. The hitch of clause 21, wherein the hitch body comprises a pivot support portion, the pivot support portion comprising a pair of spaced of openings, and wherein the pintle horn comprises a pair of arms configured to sandwich the pivot support portion, each of the arms having openings configured to align with the openings of the pivot support portion.

Clause 23. The hitch of clause 22, wherein the arms of pintle horn are sandwiched between the arms of the flapper.

Clause 24. The hitch of clause 22, wherein pivot pin extends through the arms of the flapper, the arms of the pintle horn, and the pivot support portion, such that the flapper and the pintle horn rotate about a common axis.

Clause 25. The hitch of clause 24, wherein the pivot pin extends through an arcuate portion of a leaf spring, the leaf spring being sandwiched between the spaced openings of the pivot support portion and having a first arm abutting the hitch body and a second arm abutting the pintle hook.

Clause 26. The hitch of clause 25, wherein the leaf spring is biased to push the pintle hook in a downward direction such that the pintle hook is maintained in a closed position with respect to the pintle horn.

Clause 27. The hitch of clause 21, wherein a top portion of the hitch body comprises a projection, the projection having a surface configured to interface with detents in the arms of the flapper such that an interference fit between the detents and projection maintains the flapper in an upward position.

Clause 28. A hitch for a snowmobile comprising:
a hitch body, the hitch body having a forward mounting plate portion with a plurality of mounting holes, a pintle hook support portion extending rearwardly, a pivot pin aperture extending therethrough, and further having horizontally extending locking aperture opening, the hitch body further having a pintle hitch horn extending rearwardly and a flapper support portion;
a pintle hitch latch having a pivot pin and a locking pin portion in a fixed relationship, the pivot pin extending horizontally through the pintle hitch hook support portion, the locking pin portion extendable into the locking aperture openings providing a locked positions and retractable from either of the two locked positions to a transition position;
a pintle hook pivotally attached to the hitch body at the pintle hood support portion at the pintle hitch latch pivot pin, the pintle hook movable from an open to a closed position by moving the locking pin portion to the transition position and rotating the pintle hitch latch.

Clause 29. The hitch of clause 28, further comprising a V-shaped flapper having a pair of arms with arm ends, the arm ends pivotally attached to the flapper support portion of the hitch body, the V-shaped flapper hitch movable between a downward position and an upward position.

Clause 30. The hitch of clause 29, further comprising a pair of spacers positioned between the arm ends of the V-shaped flapper and the hitch body providing resistance to movement of the V-shaped flapper and sound reduction of such movement.

Clause 31. The hitch of any of the above clauses 1-30, further comprising a snowmobile and wherein the hitch is attached to the snowmobile.

Each feature disclosed in this specification (including references incorporated by reference, any accompanying claims, abstract and drawings) may be replaced by alternative features serving the same, equivalent, or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any incorporated by reference references, any accompanying claims, abstract and drawings), or to any novel one, or any novel combination, of the steps of any method or process so disclosed.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents, as well as the following illustrative aspects. The above described aspects embodiments of the invention are merely descriptive of its principles and are not to be considered limiting. Further modifications of the invention herein disclosed will occur to those skilled in the respective arts and all such modifications are deemed to be within the scope of the invention.

1. A hitch for a snowmobile comprising:
a hitch body, the hitch body having a forward mounting plate portion with a plurality of mounting holes, a pintle hook support portion extending rearwardly, a pivot pin aperture extending therethrough, and further having a horizontally extending locking aperture opening, the hitch body further having a pintle hitch horn extending rearwardly and a flapper support portion;
a pintle hitch latch having a pivot pin and a locking pin portion in a fixed relationship, the pivot pin extending horizontally through the pintle hitch hook support portion, the locking pin portion extendable into the locking aperture opening providing a locked closed position and retractable from the locked closed position to a transition position;
a pintle hook pivotally attached to the hitch body at the pintle hook support portion at the pintle hitch latch pivot pin, the pintle hook movable from an open to a closed position by moving the locking pin portion to the transition position and rotating the pintle hitch latch;
a V-shaped flapper having a pair of arms with arm ends, the arm ends pivotally attached.

2. The hitch of claim 1, wherein the flapper support portion of the hitch body has an aperture extending therethrough and the V-shaped flapper is pivotally supported at the flapper support portion by a flapper pin extending through the aperture and through a pair of openings in respective ones of the arm ends of the flapper.

3. The hitch of claim 1, further comprising a pair of spacers positioned between the arm ends of the V-shaped flapper and the hitch body providing resistance to movement of the V-shaped flapper and sound reduction of such movement and wherein each of the pair of spacers extend at least partially around the arm ends of the V-shaped flapper.

4. The hitch of claim 1, further comprising a spring connected between the hitch body and the pintle hitch latch for urging the latch toward the lock position.

5. The hitch of claim 1, wherein the V-shaped flapper has a hole positioned at a rearward apex.

6. The hitch of claim 1, wherein the hitch has a detent to provide a position fixation of the flapper.

7. The hitch of claim 1, wherein the body has a second horizontally extending locking aperture for pintle pin and for retention of the hook in a locked open position.

8. The hitch of claim 1, wherein the hook is releaseable from a locked closed position and is movable to an open position by grasping, the handle, pulling the handle, and rotating the handle.

9. A hitch comprising a hitch body and a V-shaped flapper connected to the hitch body, the V-shaped flapper having a pair of arms joined at an apex and separated at the hitch body, each of the pair of arms having an arm end pivotally attached to the hitch body, the hitch further comprising at least one polymeric spacer positioned at each of the pair of arm ends and interfacing with said pair of arm ends and with the hitch body thereby providing resistance to pivotal motion of the flapper with respect to the hitch body.

10. The hitch of claim 9, wherein the polymeric spacers are configured to rotate with the flapper when the flapper rotates, and wherein each spacer has a recess therein to interface with a respective one of a pair of projections on the hitch body to provide a positional fixation of the flapper with respect to the hitch body.

11. The hitch of claim 9, wherein the hitch body has rearward projecting horn and further has a pintle hook support portion; wherein the hitch further comprises a hook pivotally attached to the hitch body at the pintle hook support portion, the hook movable between an open and a closed position with respect to the horn.

12. The hitch of claim 11, wherein the hook is lockable in either of the open and the closed positions.

13. The hitch of claim 12, further comprising a latch having a pivot pin, a locking pin portion, and a handle, and wherein the position of the hook and the locking of the hook is manipulatable by the handle.

14. A hitch comprising a hitch body with pintle hitch support portion and a pintle horn, the hitch further comprising a pintle hook pivotally attached to the hitch body, the hitch further comprising a pintle hitch latch having a pivot pin and a locking pin portion in a fixed relationship, the pivot pin extending horizontally through the pintle hitch hook support portion, the locking pin portion extendable into either of two locking aperture openings in the pintle hook supporting portion providing a pair of lockable positions where the hitch is open and closed.

15. The hitch of claim 14, wherein the handle of the latch is manipulatable to unlock the hook from a locked position at one of the open and closed position and to move the hook to the other of the open and closed positions by a pulling and twisting motion.

16. The hitch of claim 14, wherein the hitch body further comprises a flapper support portion, and the hitch further comprises a flapper.

17. The hitch of claim 16, wherein the flapper is V-shaped and the flapper defines a pair of arms each with an arm end, and wherein the flapper is pivotally connected to the hitch body at the arm ends, and wherein the hitch further comprises a pair of spacers, with the spacers respectively interfacing with one of the arm ends and the hitch body.

18. The hitch of claim 14, wherein when the hitch is in the locked closed position there is a gap between the pintle hook and the pintle horn for noise reduction.

19. The hitch of claim 18, wherein each of the pair of spacers comprises a polymer and is configured to rotate as the flapper rotates with respect to the hitch body, and wherein the spacer provides friction to resist rotation of the flapper with respect to the hitch body.

20. The hitch of claim 19, wherein each of the spacers comprises a detent that is engageable with a respective projection on the hitch body to provide a positional fixation of the flapper with respect to the hitch body.
